(19) United States
(12) Patent Application Publication
(10) Pub. No.: US 2025/0189390 A1
(43) Pub. Date: Jun. 12, 2025

(54) SCAFFOLDING LOAD CONTROL AND MONITORING DEVICE AND SYSTEM FOR SUCH PURPOSES

(71) Applicant: SCAFF LOAD S.A., Warszawa (PL)

(72) Inventors: ADAM MISIOR, Warszawa (PL); Damian BULINSKI, Warszawa (PL)

(21) Appl. No.: 18/845,419

(22) PCT Filed: Mar. 7, 2022
(86) PCT No.: PCT/PL2022/050012

§ 371 Date: Sep. 9, 2024

(51) Int. Cl. G01L 5/00; G01L 1/22; G08C 17/02

(52) U.S. Cl. CPC G01L 5/00; G01L 1/22; G08C 17/02

(57) ABSTRACT

A device has a body that is placed on the ground under the foot of the scaffolding vertical stand, where the body has a base and four side walls, where a strain gauge pressure sensor with a vertical measuring pin pointing upwards is mounted inside the body and located between two linear guides with a vertical axis of operation, where the lower parts of the linear guides are attached to the base of the body, while the upper parts of these guides are connected to the horizontal measuring plate, where outside the body there are handles for positioning and carrying the device, as well as the casing of the signalling and measuring unit and the communication antenna, where the signalling and measuring unit of this device comprises a controller with a wireless communication module, a display, a replaceable power source, a signalling module and manual control means.

The subject of the invention is a device for controlling and monitoring the self and service loads of a scaffolding structure, set on the ground using of vertical stands, by means of continuous measurement of the force imposed on the ground by a selected stand of the scaffolding structure, and a system for such purposes.

The patent specification no. PL232389 discloses a device for testing the actual forces acting on a scaffolding vertical stand. It comprises a body that is placed on the ground and a pressure sensor mounted inside this body, on which a scaffolding vertical stand acts from above.

The aim of the invention was to obtain the possibility of current measurement of the force imposed on the ground at a given moment by the selected stand of the scaffolding structure and signalling if this force exceeds the set value.

This aim is achieved by a device according to the invention, which comprises a body that can be placed on a ground and a pressure sensor mounted therein. A scaffolding vertical stand acts on this sensor from above. The invention is based on that the body has a base and four side walls. Inside the body a strain gauge pressure sensor with a vertical measuring pin pointing upwards is attached to its base. The pressure sensor is located between two linear guides acting in a vertical axis. The lower parts of both linear guides are attached to the base of the device body, while the upper parts of these guides are connected to the horizontal measuring plate, which is in constant contact with the pressure sensor measuring pin. On the outside of the body, on its two opposite walls, there are handles for positioning and carrying the device. On the third wall of the body there is a casing of the signalling and measuring unit, which includes a controller with a wireless communication module, a display, a replaceable power source, advantageously a battery, a signalling module and means for manual control of the device. The communication antenna is located on the fourth side of the body.

In one of variants of the device according to the invention, the walls of its body form a cuboid, advantageously with a square base. The pressure sensor is centrally located on this base, and both linear guides are located symmetrically on both sides of the sensor, on the diagonal of the body base.

In another variant of the device according to the invention, the lower part of the linear guide of the measuring plate is in the form of a vertical sleeve with an outer cylindrical plain bearing. The upper part of this linear guide is a vertical shaft with a diameter corresponding to the inner diameter of the plain bearing of the lower part. The vertical shaft has an intermediate fastening part on the top, fixed on the bottom to the measuring plate, and on the bottom this shaft has a special part preventing it from slipping out of the lower part of the linear guide. In next variant of the device according to the invention, an intermediate measuring pin is provided between the pressure sensor pin and the measuring plate, which has an upper positioning element that fits into a correspondingly shaped positioning hole in the measuring plate.

In next variant of the device according to the invention, the additional fastening part of the linear guide is in the form of a vertical sleeve with a flange entering a cylindrical recess on the lower surface of the measurement plate.

In another variant of the device according to the invention, along the sides of the measurement plate there are projections limiting the lateral movement of the foot of the vertical scaffolding stand, and on the outer surface of the fourth body wall there is a casing for the communication antenna in the shape of a truncated pyramid.

In yet another variant of the device according to the invention, the handles and the casing of the signalling unit are in the form of truncated pyramids.

The system according to the invention comprises at least one measuring unit and at least one signalling and alarm unit, which are wirelessly connected to each other. The invention is based on the fact that the measuring unit is a device according to the invention described above. Both types of units forming the system according to the invention include units for identification by means of radio waves (Radio Frequency Identification—RFID). Moreover, the signalling and alarm unit comprises fastening means for hanging it, means of acoustic and light signalling, a controller with a wireless communication module and an identification module, a display, a replaceable power source, and means for manual control of the signalling and alarm unit.

In one of the variants of the system according to the invention, the controller, the identification unit and the replaceable power source are located inside the casing of the signalling and measuring unit, while the acoustic and light signalling means are mounted outside the casing of this unit.

In another variant of the system according to the invention, the casing of the signalling and measuring unit is vertically divided into two parts connected with each other by hinges with a vertical axis of rotation. The fastening means and the acoustic and light signalling means of the unit are fixed to the first casing part, while the display and manual control means are provided on the second part of the casing.

The invention radically increases the safety of work on the construction site, and the safety of third parties in the case of scaffolding structures placed directly on the streets, as it allows the user to control the load on the scaffolding structure on an ongoing basis and send measurement results and alarm signals in the case the permissible load is exceeded, considering even many parts of the scaffolding, without interference into its very structure. The system according to the invention generates, if necessary, an alarm signal sent to mobile devices as well as a sound and light signal. It allows one to make a quick decision to evacuate workers and/or reduce the load on the structure. The low height of the device according to the invention allows it to be installed under the base plates of an already erected scaffolding structure and, if necessary, to quickly change the place of inspection or measurement. Reading of the current load and setting a specific threshold that triggers an alarm is possible both remotely and manually. Autonomous power supply and easy interchangeability of its sources make the application of the invention completely independent from the local power grid.

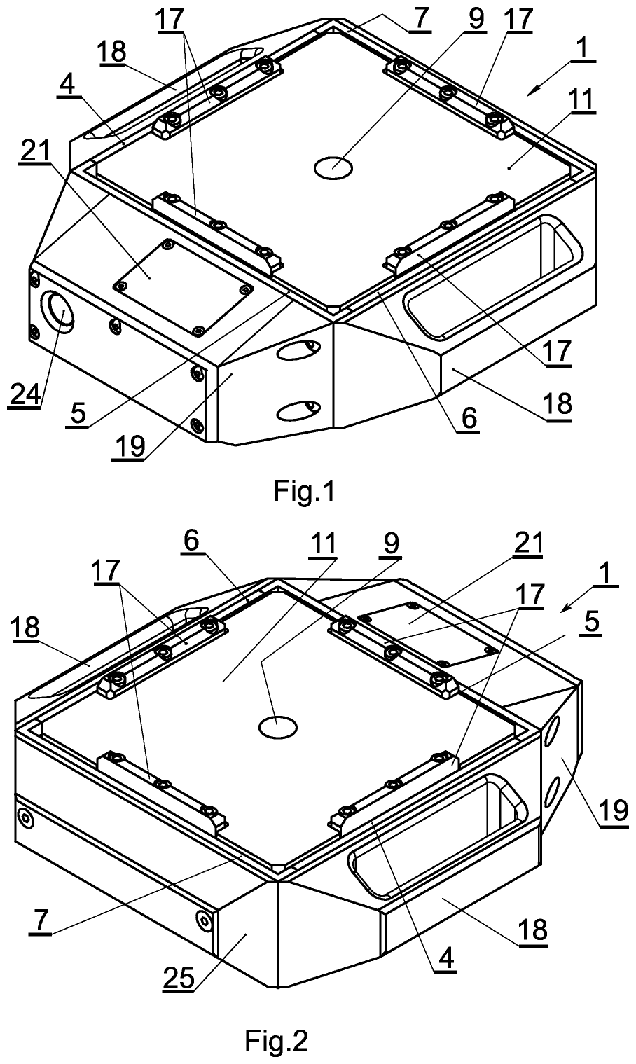

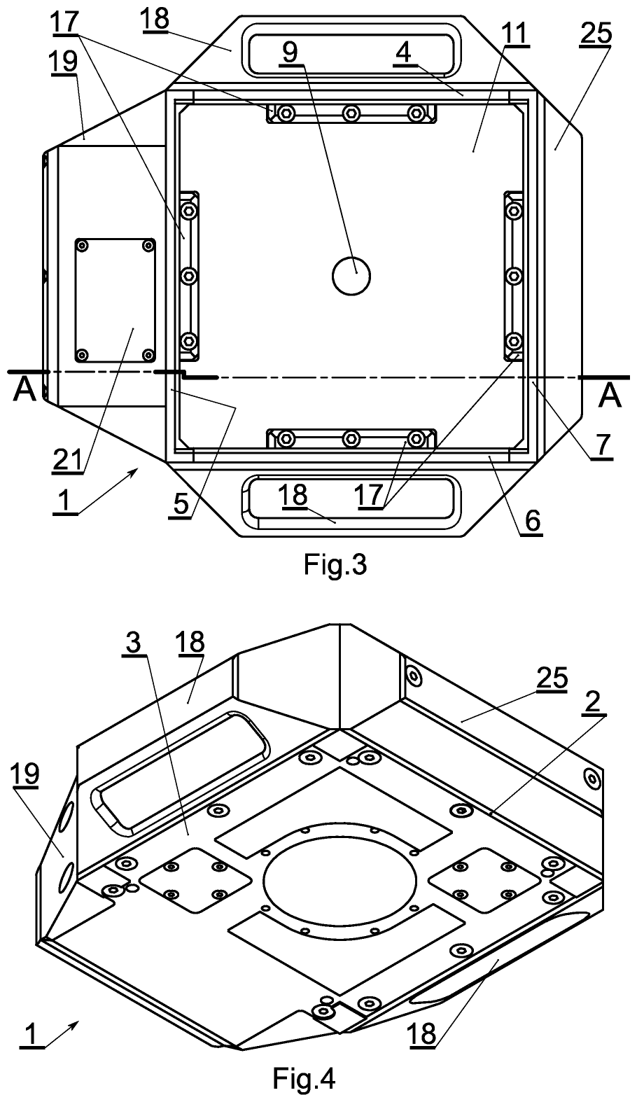

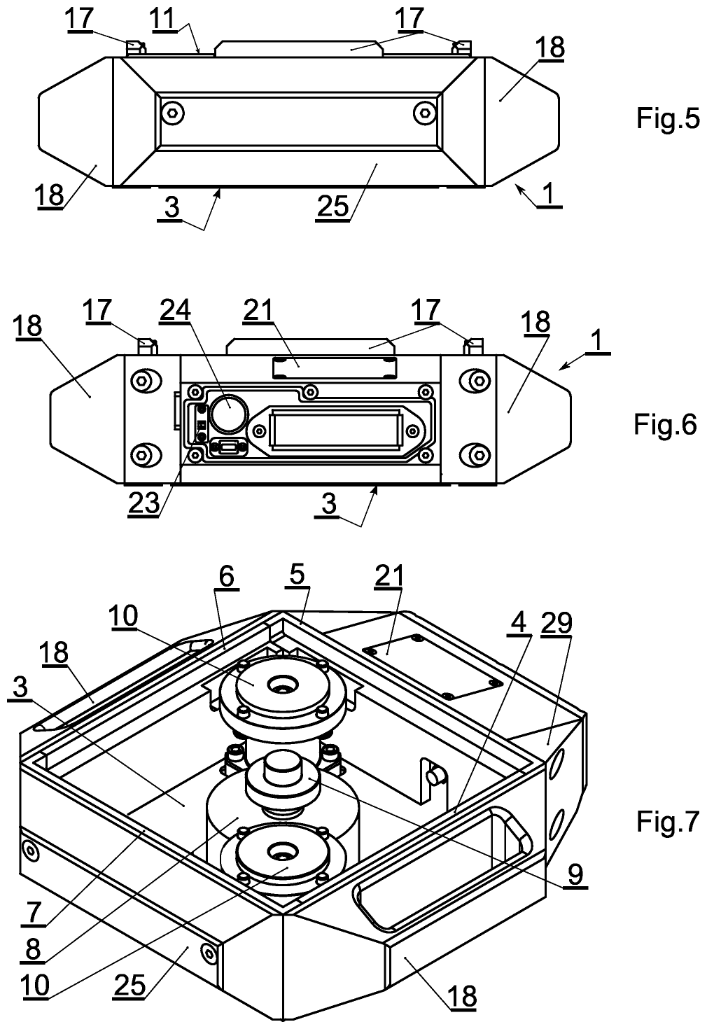

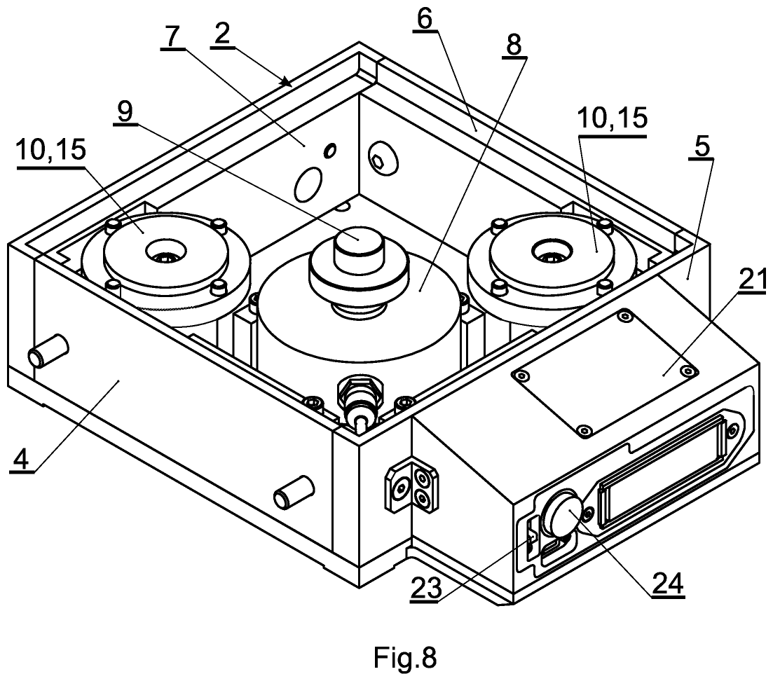

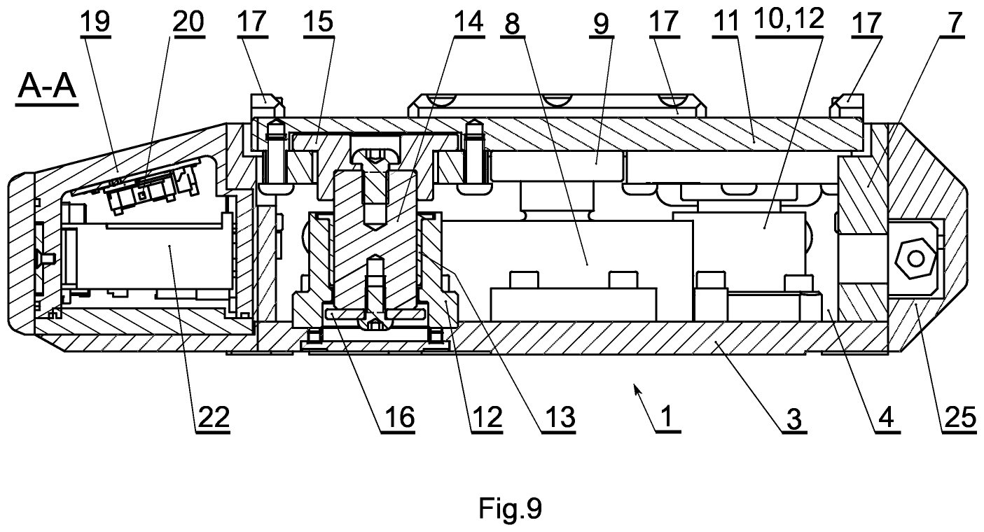

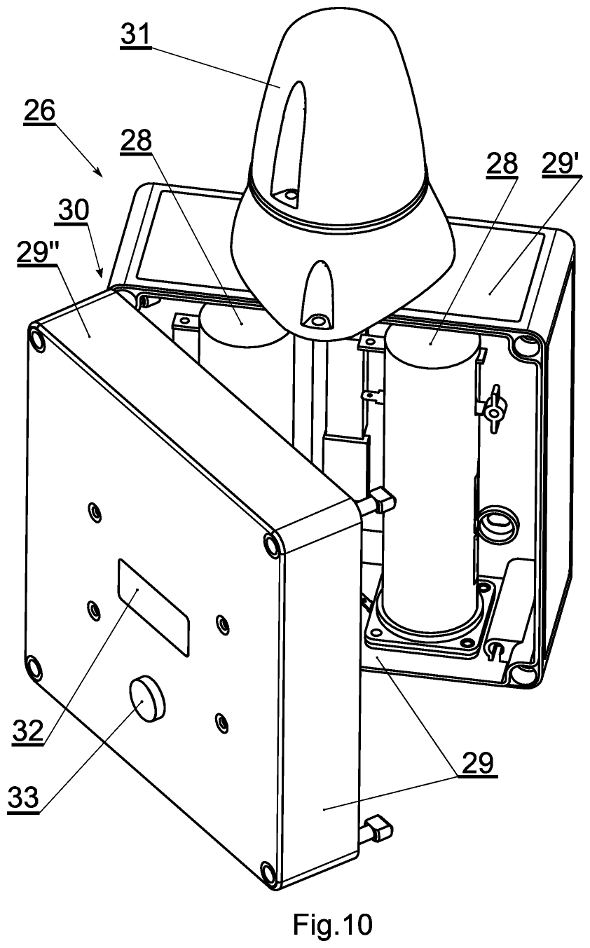

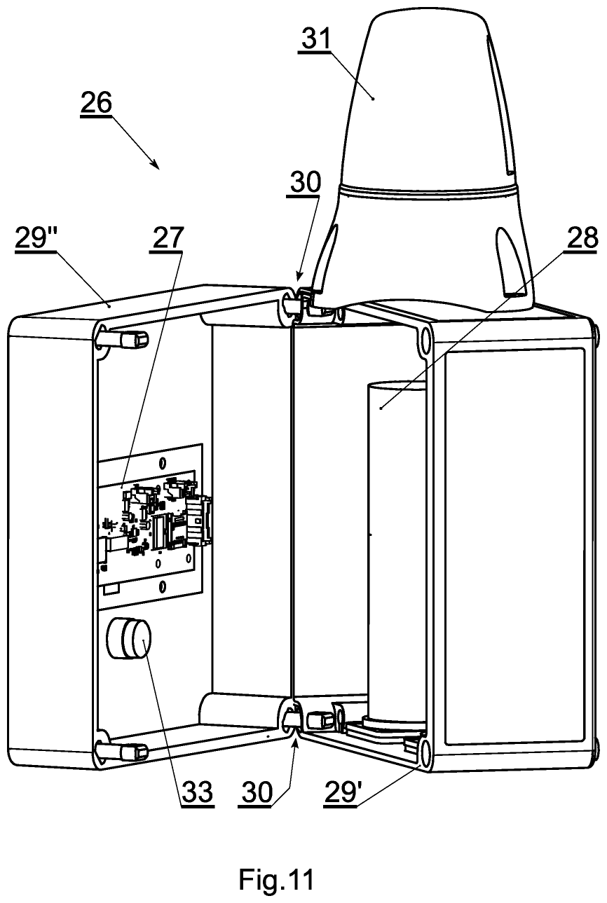

An embodiment of the invention will be described below and shown in the drawing, in which FIG. 1 is an axonometric front view of the device and FIG. 2 is an axonometric rear view of the device. FIG. 3 shows the device of FIG. 1 in a rectangular view from above, and FIG. 4 shows the device in an axonometric view from below. FIG. 5 and FIG. 6 are-respectively-orthogonal views from the front and the back of the device of FIG. 1. FIG. 7 shows the device of FIG. 2 with the measuring plate disassembled. FIG. 8 is an enlarged view of the device of FIG. 7, seen from another direction, with the handles and casings disassembled. FIG. 9 shows the device of FIG. 3 in section with a vertical plane. FIG. 10 and FIG. 11 show two axonometric views of the signalling and alarm unit according to the invention.

Exemplary monitoring device 1 comprises a steel, open-top, rectangular body 2 which has a square base 3 with dimensions of 200 by 200 mm and a thickness of 10 mm. Along the side edges of the base 3, are a first 4, a second 5, a third 6 and a fourth 7 vertical sidewalls, each 60 mm high and 15 mm thick. The base 3 and the sidewalls 4, 5, 6 and 7 are connected to each other by screws. In the interior of the body 2, a centrally mounted strain gauge 8 under the trade name Ulticell M420 is mounted to the base 3. The sensor 8 has a vertical pin with an operating stroke of 0.6 mm when loaded with a force of 50 kN. On the mentioned measuring pin, rests the intermediate measuring pin 9, which transfers the load from the scaffold to the sensor 8. On the diagonal of the base 3, on both sides of the sensor 8, there is one linear guide 10 with a vertical axis of operation. The body 2 is closed at the top by a steel measuring plate 11 with dimensions of 185 mm by 185 mm and a thickness of 10 mm. The lower part of the linear guide 10 is bolted to the base 3 and is in the form of a vertical sleeve 12 with an internal cylindrical plain bearing 13. The upper part of the linear guide 10 is a vertical shaft 14 with a diameter corresponding to the internal diameter of the plain bearing 13. The shaft 14 has an intermediate element screwed on to the top 15 in the form of a sleeve with a collar. The flange of the intermediate element 15 enters a cylindrical recess on the lower surface of the measurement plate 11 and is attached to it by means of a clamping ring and four screws. From below, the vertical shaft 14 has a securing element 16 to prevent the shaft 14 from slipping out of the bearing 13. The gauge plate 11 is in constant contact with the additional intermediate pin 9. The pin 9 has an upper cylindrical positioning element that fits into a corresponding positioning hole in the gauge plate 11. During the operation of the device 1, the base 3 of the body 2 rests on the ground, while a given known stand foot of the scaffolding to be monitored, not shown in the drawing, is set on the upper surface of the measuring plate 11. Special protrusions 17 are screwed along all four sides of the measurement plate 11 to limit the lateral movements of said foot of the vertical scaffolding stand. Outside the body 2, on the first 4 and the third 6 side walls of the body 2, there are handles 18 for positioning and carrying the device 1. On the second wall 5 of the body 2 there is a casing 19 of the signalling and measuring unit. The unit includes a controller 20 with a wireless communication module and a RFID (Radio Frequency Identification) module, display 21, replaceable supply battery 22, signalling device, switch 23 and operating button 24 for manual control of the device 1. On the fourth wall 7 of the body 2 there is a casing 25, for not shown in the drawing a communication antenna connected to the wireless communication module of the controller 20. The outer contours of the handles 18 made of polyacetal (POM-C) and the outer contours of the casings 19 and 25 made of the same material are in the form of elongated truncated pyramids. Casings 19 and 25 protect the electronic circuits built into them against damage. The completed device 1 has a height of 87 mm, a width of 280 mm and a depth of 290 mm.

The load on the simple scaffolding can be monitored even with a single device 1, but the system according to the invention, comprising of at least one device 1 and at least one signalling and alarm unit 26 external to the device 1, wirelessly connected to each other, can provide much greater efficiency. An exemplary signalling and alarm unit 26 includes a controller 27 with a unit for identification by means of radio waves of the RFID type (Radio-Frequency Identification) and NFC (Near Field Communication), as well as a replaceable power battery 28. These components are located in a rectangular casing 29, vertically divided into two parts 29′ and 29″ connected to each other by hinges 30 with a common vertical axis of rotation. Outside the casing 29 there is a known alarm signaling device 31, emitting acoustic and light signals, attached to the first part 29′ of the casing 29. On the outer wall of the first part 29′ of the casing 29 there are also, not shown, handles for fixing the casing 29 to the scaffolding structure, buildings wall or free-standing support. A display 32, visible from the outside, is attached to the second hinge-open part 29″ of the casing 29. Adjacent to the display 32, on the outer wall of the second part 29″ of the casing 29 is a function button 33 for manual control of the unit 26. The above-described scaffolding load monitoring system comprises at least one measuring device 1 as described above and at least one signalling and alarm unit 26. The measuring device 1 is placed under the selected scaffolding foot, and then the level of the permissible load at a given point of the scaffolding structure is programmed in it. When the device 1 is turned on, it measures cyclically the load exerted on the measurement plate 11 by the foot of the scaffolding. The length of the measuring cycle of device 1 may be programmed from one second to any number of hours. In the case the device 1 detects a load exceeding a predetermined level, this device sends a signal via radio to the signalling and alarm unit 26, placed in a visible place near the monitored scaffolding. The light and sound signal from the alarm siren 31 is intended to draw the attention of the persons responsible for the condition of the scaffolding and/or technical service. An alarm signal from device 1 is sent until the load at a given point in the scaffolding returns to a safe level. The alarm signal can also be muted using a known NFC access card. The signalling and alarm unit 26 is powered by replaceable batteries 28. Autonomous power supply for the components of the system according to the invention eliminates the need to route power cables along the scaffolding structure, which positively affects the work safety. The measuring device 1 and the signalling and alarm unit 26 have a common communication medium, based on the certified radio module SPSGRFC by STMicroelectronics. Radio modules, included in the controllers 20 and 27, can be made in three different versions, adapted to work at the frequencies of 433 MHZ, 868 MHz or 915 MHz, while in the described embodiment the frequency of 868 MHz was used for communication and a special communication protocol was designed for this purpose. As elements of the user interface, both in the measuring device 1 and in the signalling and alarm unit 26, a graphic display (21, 32) in OLED technology, an RGB LED signalling diode and a piezoelectric button (25, 33) were used.

1. A device for controlling and monitoring loads acting on a scaffolding structure comprising a body placed on the ground and a pressure sensor mounted therein, on which the sensor a vertical scaffolding stand acts from above, characterized in that the body (2) has a base (3) and four side walls (4,5,6,7), inside this body (2) to its base (3) a strain gauge pressure sensor (8) is mounted, having a vertical measuring pin pointing upwards and located between two linear guides (10) with a vertical axis of operation, whereas the lower parts (12, 13) of the linear guides (10) are attached to the base (3) of the body (2), and the upper parts (14, 15) of these guides (10) are connected with the horizontal measuring plate (11) being in constant contact (9) with the measuring pin of the sensor (8), whereas outside the body (2), on two opposite walls (4, 6), there are handles (18) for the device (1) positioning and carrying, and on the third wall (5) of the body (2) there is a casing (19) of the signalling and measuring unit, which includes a controller (20) with a wireless communication module, a display (21), a replaceable power source (22), advantageously a battery, an indicator and manual control means (24) of the device (1), while on the fourth wall (7) a communication antenna is located.

2. The device according to claim 1, characterized in that the walls (4, 5, 6, 7) of the body (2) form a cuboid, advantageously with a square base, the pressure sensor (8) is centrally located on this base (3), and the both linear guides (10) are located symmetrically on both sides of the sensor (8), on the diagonal of the body (2) base (3).

3. The device according to claim 1, characterized in that the lower part of the linear guide (10) has a form of a vertical sleeve (12) with an internal cylindrical plain bearing (13), whereas the upper part of the linear guide (10) is a vertical shaft (14) with a diameter corresponding to the internal diameter of the plain bearing (13), while the vertical shaft (14) has an intermediate fastening element (15) at the top, fixed at the bottom to the measuring plate (11), and the bottom vertical shaft (14) has an element preventing the shaft (14) from slipping out of the lower part (12, 13) of the linear guide (10).

4. The device according to claim 1, characterized in that between the measuring pin of the sensor (8) and the measurement plate (11) is located an intermediate pin (9) with upper positioning element entering the positioning hole of the corresponding shape in the measurement plate (11).

5. The device according to claim 2, characterized in that the intermediate fastening element (15) of the linear guide (10) is in a form of a sleeve with a flange entering into a cylindrical recess on the lower surface of the measurement plate (11).

6. The device according to claim 1, characterized in that along the sides of the measuring plate (11) there are protrusions (17) limiting the lateral movement of the foot of the scaffolding vertical stand, and on the outer surface of the fourth wall (7) of the body (2) there is a communication antenna casing (25) in a shape of a truncated pyramid.

7. The device according to claim 1, characterized in that the handles (18) and the casing (19) of the signalling unit are in the form of truncated pyramids.

8. A system for controlling and monitoring loads on the scaffolding structure, comprising at least one measuring unit and at least one signalling and alarm unit, wirelessly connected to each other, characterized in that the measuring unit is a monitoring device (1), both types of units (1, 26) forming the system include Radio-Frequency Identification (RFID) units, and the signalling and alarm unit (26) has means for hanging it, acoustic and light signalling means (31), a controller (27) with a wireless communication module and with an identification module, a display (32), a replaceable power source (28), and means for manual control (33) of the signalling and alarm unit (26).

9. The system according to claim 8, characterized in that the controller (27), the identification unit, and the replaceable power source (28) are located inside the casing (29) of the signalling and alarm unit (26), and the acoustic and light signalling means (31) are mounted on the outside of the casing (29) of the unit (26).

10. The system according to the claim 9, characterized in that the casing (29) of the signalling and alarm unit (26) has a shape of a cuboid divided vertically into two parts (29′, 29″), these parts (29′, 29″) are connected by hinge means (30) with a vertical axis of rotation, the fastening means and the acoustic and light signalling means (31) are attached to the first part (29′) of the casing (29), while the display (32) and manual control means (33) are located on the second part (29″) of the casing (29).

11. The device according to claim 2, characterized in that the lower part of the linear guide (10) has a form of a vertical sleeve (12) with an internal cylindrical plain bearing (13), whereas the upper part of the linear guide (10) is a vertical shaft (14) with a diameter corresponding to the internal diameter of the plain bearing (13), while the vertical shaft (14) has an intermediate fastening element (15) at the top, fixed at the bottom to the measuring plate (11), and the bottom vertical shaft (14) has an element preventing the shaft (14) from slipping out of the lower part (12, 13) of the linear guide (10).

12. The device according to claim 2, characterized in that between the measuring pin of the sensor (8) and the measurement plate (11) is located an intermediate pin (9) with upper positioning element entering the positioning hole of the corresponding shape in the measurement plate (11).

13. The device according to claim 3, characterized in that between the measuring pin of the sensor (8) and the measurement plate (11) is located an intermediate pin (9) with upper positioning element entering the positioning hole of the corresponding shape in the measurement plate (11).

14. The device according to claim 3, characterized in that the intermediate fastening element (15) of the linear guide (10) is in a form of a sleeve with a flange entering into a cylindrical recess on the lower surface of the measurement plate (11).

15. The device according to claim 4, characterized in that the intermediate fastening element (15) of the linear guide (10) is in a form of a sleeve with a flange entering into a cylindrical recess on the lower surface of the measurement plate (11).

16. The device according to claim 2, characterized in that along the sides of the measuring plate (11) there are protrusions (17) limiting the lateral movement of the foot of the scaffolding vertical stand, and on the outer surface of the fourth wall (7) of the body (2) there is a communication antenna casing (25) in a shape of a truncated pyramid.

17. The device according to claim 3, characterized in that along the sides of the measuring plate (11) there are protrusions (17) limiting the lateral movement of the foot of the scaffolding vertical stand, and on the outer surface of the fourth wall (7) of the body (2) there is a communication antenna casing (25) in a shape of a truncated pyramid.

18. The device according to claim 4, characterized in that along the sides of the measuring plate (11) there are protrusions (17) limiting the lateral movement of the foot of the scaffolding vertical stand, and on the outer surface of the fourth wall (7) of the body (2) there is a communication antenna casing (25) in a shape of a truncated pyramid.

19. The device according to claim 5, characterized in that along the sides of the measuring plate (11) there are protrusions (17) limiting the lateral movement of the foot of the scaffolding vertical stand, and on the outer surface of the fourth wall (7) of the body (2) there is a communication antenna casing (25) in a shape of a truncated pyramid.

20. The device according to claim 2, characterized in that the handles (18) and the casing (19) of the signalling unit are in the form of truncated pyramids.
